(19) United States
(12) Patent Application Publication
(10) Pub. No.: US 2025/0343871 A1
(43) Pub. Date: Nov. 6, 2025

(54) METHOD FOR RECORDING CAMERA IMAGE DATA ON AN EDGE SERVER AND DATA PROCESSING DEVICE

(71) Applicant: Arnold & Richter Cine Technik GmbH & Co. Betriebs KG, München (DE)

(72) Inventor: Kostyantyn BOBROVSKYY, München (DE)

(21) Appl. No.: 19/197,211

(22) Filed: May 2, 2025

(30) Foreign Application Priority Data
May 3, 2024 (DE) 102024112512.8

(51) Int. Cl. H04N 5/77; H04N 5/913

(52) U.S. Cl. CPC H04N 5/77; H04N 5/913; H04N 2005/91357

(57) ABSTRACT

A method for recording camera image data on an edge server comprises the steps recording a scene by a motion picture camera and generating camera image data that represent the scene by the motion picture camera, and transmitting the camera image data to the edge server. However, in a data transmission path from the motion picture camera to the edge server, a buffer memory device comprising a non-volatile data memory is arranged between the motion picture camera and the edge server, wherein the camera image data are first written to the data memory of the buffer memory device and the camera image data written to the data memory are then transmitted from the buffer memory device to the edge server.

The invention relates to a method for recording camera image data on an edge server, in which a scene is recorded by a motion picture camera and camera image data that represent the scene are generated by the motion picture camera. The camera image data are further transmitted to the edge server.

Furthermore, the invention relates to a data processing device for processing camera image data that are generated by a motion picture camera during a motion picture recording and that represent a recorded scene, wherein the data processing device comprises an edge server that is configured to receive the camera image data and to forward the received camera image data to systems arranged downstream.

In principle, a scene may be recorded by a motion picture camera during motion picture recordings, for example in an image recording studio, to generate camera image data that represent the recorded scene. The generated camera image data must then be stored, wherein, however, in view of the amounts of data that are already currently achieved, in particular during professional motion picture recordings, a purely local storage at the motion picture camera is precluded and a transmission of the camera image data to separate storage media must take place. Furthermore, a transmission of the camera image data to a suitable device for a subsequent processing may possibly be necessary.

The motion picture camera may therefore be connectable via a local connection, for example a cable connection or a local WLAN/WiFi connection, to an edge server to which the camera image data are transmitted in order to permanently store the camera image data and, if necessary, to transmit said data to systems arranged downstream for a further processing. In particular, the edge server may to that effect form a local connection point for the motion picture camera in order to transmit camera image data generated by the motion picture camera to, for example, a cloud-based server architecture and to be able to use its storage and/or computing capacity during the further storage and processing of the camera image data. Furthermore, a processing of the received data may also already take place at the edge server.

However, in particular in the course of the continuous further development of motion picture cameras, the problem arises that increasingly large amounts of data have to be generated and transmitted to the edge server so that conventional edge servers appear, at least in the long term, to no longer be able to reliably meet the requirements for a transmission of such amounts of data in real time. However, for instance, a timeout or dropout with respect to the receiving of camera image data may lead to a loss of camera image data since the motion picture camera constantly generates further camera image data during a recording so that the generated camera image data must be handled in real time.

In this regard, existing structures may record camera image data that are generated during a motion picture recording at an edge server at most at limited data rates so that the existing structures may no longer meet the requirements, at least in the long term. Alternatively, the camera image data could already be compressed before the transmission to the edge server, wherein, however, in particular the use of all the camera image data generated by the motion picture camera, and in particular of all the image data that represent the scene, without a prior processing or compression may be desired so that such a compression is also ruled out for many applications.

It is therefore an object of the invention to provide a method and a data processing device that enable a reliable recording of camera image data at an edge server at high data rates.

This object is satisfied by a method according to the independent claim 1.

In this method, in a data transmission path from the motion picture camera to the edge server, a buffer memory device comprising a non-volatile data memory is arranged between the motion picture camera and the edge server, and the camera image data are first written to the data memory of the buffer memory device, wherein the camera image data written to the data memory are then transmitted from the buffer memory device to the edge server

The edge server may generally be a normal computer, a server or a high-performance PC that is located close to the motion picture camera. For example, the edge server may therefore be connected to the motion picture camera via a wired connection or via a local wireless radio connection, such as a local WiFi connection or a local WLAN. In this regard, the edge server in particular differs from servers or computers which are located remotely from the motion picture camera and to which the motion picture camera is, for example, only indirectly connected via the Internet and which may, for instance, form a cloud architecture. In particular, the edge server may therefore form a direct local connection point for the motion picture camera without further servers or computers being disposed between the motion picture camera and the edge server. The edge server may therefore be provided to receive the camera image data of the motion picture camera as the first computer or server in order to then forward the received camera image data to further local or external, such as cloud-based, computers or memory modules.

However, unlike in conventional methods for recording camera image data, the camera image data are not transmitted directly to the edge server, but rather, in a data transmission path from the motion picture camera to the edge server, a buffer memory device comprising a non-volatile data memory is arranged between the motion picture camera and the edge server, and the camera image data are first written to the data memory of the buffer memory device and are only then transmitted from the data memory of the buffer memory device to the edge server.

While further processes, such as forwarding the camera image data to systems arranged downstream and/or any image editing processes, may generally run on the edge server in addition to receiving and storing the camera image data, the buffer memory device may in particular be adapted and optimized for receiving and storing the camera image data so that the camera image data may also be written at high data rates to the non-volatile data memory of the buffer memory device in real time without timeouts or dropouts due to requirements of other processes having to be expected. However, since the camera image data are ultimately to be transmitted to the edge server to be able to be received and/or forwarded by it, in particular as a connection point to a server architecture arranged downstream, the camera image data initially written in real time to the data memory of the buffer memory device are then transmitted by the buffer memory device to the edge server. This may generally take place by the buffer memory device reading the camera image data from the data memory and transmitting said data to the edge server, or by the edge server directly reading the data memory of the buffer memory device so that the edge server may possibly have read access to the camera image data stored in the data memory.

Such a procedure may, for example, make it possible to write the camera image data to the data memory of the buffer memory device in real time during a motion picture recording in order, for instance, only during a subsequent interruption of the recording, to transmit the camera image data stored in the data memory to the edge server. Thus, the recording or the generation of the camera image data by the buffer memory device may ultimately be decoupled in time from the actual reception of the camera image data at the edge server so that the edge server does not have to fulfill the requirement of receiving camera image data in real time. Rather, the buffer memory device specifically adapted for this purpose may be used so that, with respect to the transmission of the camera image data, a division, so to speak, into a real-time system—the buffer memory device—and a decoupled non-real-time system with more complex tasks that go beyond simply receiving the camera image data—the edge server—may take place.

Provision may, however, generally also be made that the buffer memory device is configured to at least partly transmit camera image data stored in the data memory to the edge server already during the motion picture recording and during the reception of further camera image data. This may, for example, be achieved by the buffer memory device being configured for a fast writing and reading in order, for instance, to be able to perform both a write step for writing in received camera image data and a read step for reading out camera image data already stored in the data memory during a time interval in which a data packet of camera image data is received from the motion picture camera at the buffer memory device.

Since the buffer memory device has a non-volatile data memory, the camera image data stored in the data memory may generally also remain stored in the data memory for a longer time so that—at least until a complete filling of the data memory with camera image data—further camera image data may always be written to and stored in the data memory. Therefore, as explained, it is possible, for example, to wait until a recording is interrupted before transmitting to the edge server, wherein the camera image data generated during the recording may be safely received and stored in the data memory. In contrast to a merely volatile data memory, for example a RAM (random access memory), the camera image data that are stored in the data memory and possibly not yet transmitted to the edge server may furthermore continue to be safely stored in the data memory if the buffer memory device and/or the edge server is/are disconnected from a power supply. In this regard, the buffer memory device may possibly also directly enable the creation of backup copies of the camera image data if, for example, the camera image data stored in the data memory are not transmitted solely to the edge server, but may, for example, also remain in the data memory at least until a complete transmission of the camera image data.

The data memory may in particular be based on HDD (Hybrid Hard Drive) technology or SSD (Solid State Drive) technology.

In summary, the arrangement of the buffer memory device in the data transmission path from the motion picture camera to the edge server thus so-to-say enables a temporal decoupling between the execution of the recording, on the one hand, and the reception of the camera image data at the edge server, on the other hand. The camera image data generated by the motion picture camera may be transmitted in real time to the buffer memory device and written to the data memory there, whereas the edge server no longer needs to provide a real-time capacity for receiving the camera image data. While the method is explained here in connection with the recording of camera image data on an edge server, such a procedure and a structure with a buffer memory device are therefore generally suitable in situations in which high data rates have to be transmitted to an edge server so that the real-time capacity of the edge server may be questionable.

Therefore, the invention also generally relates to a method for recording data on an edge server, comprising the steps:
generating the data, and
transmitting the data to the edge server,

wherein, in a data transmission path from a device generating the data to the edge server between the device generating the data and the edge server, a buffer memory device comprising a non-volatile data memory is arranged, wherein the data are first written to the data memory of the buffer memory device and the data written to the data memory are then transmitted from the buffer memory device to the edge server.

In principle, in this more general method, one or more of the steps explained above and below may be provided and/or one or more features of the buffer memory device and/or of the edge server may be implemented.

In general, such a method may be considered for applications in which a generally arbitrary sensor acquires physical data and—at a high data rate—converts said physical data into digital data, wherein the digital data must be recorded in real time. Such a sensor (in particular as a device generating the data or as a component of a device generating the data) may, for example, be configured as an image sensor of a camera for generating camera image data, as already explained above for a possible application of the method disclosed herein. Alternatively thereto, however, in particular medical and possibly imaging processes in medical technology may also be considered in which data to be processed or at least stored in real time may be generated at high data rates. For example, a sensor generating the data may therefore be configured, for instance, as a magnetic resonance imaging sensor, a LIDAR sensor, an X-ray flat panel sensor (flat-panel detector) or a computed tomography sensor. Furthermore, corresponding sensors may also be used in industrial applications, for instance, to inspect workpieces.

In view of the increasing use of AI (artificial intelligence), the processing of data generated by AI furthermore results as a further application. For example, AI may be used to simulate or evaluate complex processes, wherein large amounts of data may be generated at high data rates and must be stored without a loss of data. Here, too, the method explained may be used in that the data generated by the AI may first be stored in the data memory of the buffer memory device and may only then be transmitted to an edge server, for instance during an interruption of the data generation.

Further embodiments are explained in the dependent claims, in the description, and with reference to the drawings.

In some embodiments, the camera image data may be transmitted to the edge server during an interruption of the recording by the motion picture camera. Furthermore, in such embodiments, it may in particular be provided that no camera image data are transmitted from the buffer memory device to the edge server during the recording. As explained, as result of this and due to the configuration of the buffer memory device with a non-volatile data memory, a complete temporal decoupling between the generation of the camera image data and their transmission to the edge server may thus be achieved.

Furthermore, in some embodiments, camera image data transmitted to the edge server may be deleted from the data memory of the buffer memory device. Due to such a procedure, it may in particular be achieved that a sufficient storage capacity for receiving further camera image data is always available at the data memory, in particular those camera image data which are generated when a motion picture recording is resumed after an interruption.

In some embodiments, the camera image data may comprise image data that represent respective images of the scene as well as audio data and/or metadata that are related to the recording. The metadata may in particular comprise lens settings of a camera lens of the motion picture camera, information about a camera position, type information about a device type of the motion picture camera, a frame rate, an image format and/or information of an acceleration sensor connected to the motion picture camera.

The image data may, for example, be transmitted in a 4K format, in particular in a UHD (Ultra High Definition) format and a DCI (Digital Cinema Initiatives) format, or in an 8K format so that the image data to be transmitted may already involve relatively large amounts of data. In particular with a high frame rate or image recording frequency of the motion picture camera, high data rates may thus be generated at the motion picture camera that may have to be stored accordingly. In addition to the image data, audio data may moreover also be generated by the camera to be able to record an audio track during the recording of the scene.

Furthermore, an increasing multitude of metadata may be generated during recordings with motion picture cameras to collect additional information for a subsequent image processing or a post-production. Thus, for example, information with respect to the lens settings of a camera lens of the motion picture camera, such as a focus setting, an aperture, a zoom setting and/or a focal width, may be transmitted to be able to subsequently evaluate and/or use this information.

In particular in the case of professional motion picture recordings, large data rates may therefore already be generated at the present time so that the required recording of the generated camera image data in real time may in particular be problematic in this field. By storing the generated camera image data in the data memory of the buffer memory device, a reliable possibility of receiving and storing the camera image data in real time without the risk of losing camera image data may thus be provided—even at the still increasing data rates to be expected in the future.

In some embodiments, the camera image data may be written to the data memory of the buffer memory device at a data rate of at least 10 Gbit per second or at least 25 Gbit per second or at least 80 Gbit per second. Accordingly, the buffer memory device may be configured to reliably write camera image data (or other data) received at such data rates to the data memory in real time. Furthermore, in some embodiments, the camera image data may be written to the data memory at a data rate of at least 100 Gbit per second.

In some embodiments, the data memory of the buffer memory device may provide a storage capacity of at least 1 TB (terabyte).

In this regard, the data memory may be a data memory with a relatively large storage capacity and not just a small buffer memory or working memory to which small amounts of data may be written for a short time. Rather, the data memory in particular has sufficient storage capacity in order, in professional motion picture recordings, to completely write camera image data generated during the recording of a scene to the data memory so that the data memory may, for example, only be read out after the recording of the corresponding scene has ended in order to transmit the camera image data stored in the data memory to the edge server.

Accordingly, the buffer memory device may be configured to write camera image data to the data memory for the duration of the recording of a scene and the data memory may be configured to have a sufficient storage capacity to be able to reliably store the camera image data generated during the recording of the scene in the data memory. The storage capacity of the data memory may therefore in particular correspond to at least one amount of data generated by the motion picture camera during the expected or specified duration of the scene or may exceed this amount of data.

In some embodiments, the data memory may also have a storage capacity of at least 5 TB (terabytes), at least 10 TB (terabytes), at least 20 TB (terabytes), at least 50 TB (terabytes) or at least 100 TB (terabytes).

In some embodiments, the buffer memory device may be mechanically coupled to the edge server. In this regard, the buffer memory device may in particular be connected to the edge server as a separate device viewed relative to the edge server and may not be directly implemented as a component, in particular a memory module, of the edge server. Nevertheless, even in such embodiments, it is not ruled out that the buffer memory device and the edge server are surrounded by a common housing, for example.

Since the buffer memory device may be mechanically coupled to the edge server, a retrofitting of existing edge servers or computers within the meaning of the present disclosure may in particular also be possible by attaching a buffer memory device to the edge server or by arranging the buffer memory device in a data transmission path from a motion picture camera (or another device for generating data) to the edge server. The system comprising the buffer memory device and the edge server may thus in particular be a system comprising two separate components and not an edge server that is further developed in itself.

In some embodiments, the camera image data may be transmitted to the buffer memory device via an Ethernet connection. Alternatively or additionally, the camera image data may be transmitted from the buffer memory device to the edge server via a PCI Express (Peripheral Component Interconnect Express).

In particular, an Ethernet connection may enable the transmission of camera image data at the required data rates. The transmission of the camera image data via a PCI Express from the buffer memory device to the edge server may enable a simple, secure and fast data transmission to the edge server.

In some embodiments, the buffer memory device may comprise a control device, wherein the control device may comprise a smart network interface card, an FPGA (Field Programmable Gate Array) and/or an ASIC (Application-Specific Integrated Circuit).

In particular, the buffer memory device may have its own control device that is completely independent of a control device and/or a server OS (operating system) of the edge server. The control device of the buffer memory device may in particular be configured to write the received camera image data to the data memory and/or to read said data from the data memory and/or to transmit said data to the edge server.

Since the buffer memory device may have a control device, the buffer memory device may in particular be completely independent in terms of control and may be decoupled from a control device of the edge server. Therefore, due to such a control device, a complete separation between a real-time system of the buffer memory device and a system of the edge server that does not work in real time with respect to the receiving of the camera image data may ultimately be implemented. In some embodiments, the control device of the buffer memory device may furthermore not be controllable by a control device of the edge server so that the control device of the edge server does not have to take over any tasks with respect to the writing in and/or reading out of the camera image data to the data memory or from the data memory of the buffer memory device. Any timeouts of the edge server with respect to a data reception, for instance due to other functions to be performed or processes to be controlled, therefore do not lead to a loss of data packets of the camera image data since they may be received by the control device of the buffer memory device and may be written to the data memory independently of a utilization of the control device of the edge server. Nevertheless, a communication between a control device of the buffer memory device and a control device of the edge server may generally be provided, for instance, in that the control device of the edge server may be configured to communicate to the control device of the buffer memory device if there is capacity for receiving the camera image data and the camera image data are to be transmitted. The control device of the buffer memory device may then start reading out the camera image data and/or transmitting the camera image data to the edge server.

A smart network interface card may in particular make it possible to implement the necessary steps for receiving and writing the camera image data from/to the data memory in a software-based manner at the control device of the buffer memory device. However, an FPGA and/or an ASIC may-alternatively or additionally-also enable a hardware-side implementation of one or more of these functions.

Therefore, the control device of the buffer memory device may, in principle, in particular be configurable to be able to implement the tasks of storing the received camera image data and/or of reading out the data memory and/or transmitting the read-out camera image data to the edge server.

In addition to the explained ensuring of a real-time capacity, the configuration of the buffer memory device with a separate control device may furthermore make it possible to reduce the power consumption and thus energy consumption of the system comprising the buffer memory device and the edge server compared to a control by an operating system of the edge server. The control device of the buffer memory device may be optimized for the receiving and structuring, in particular for the writing to the data memory and/or reading from the data memory, of the camera image data and may thus also be reduced to these tasks so that they may be implemented as (energy) efficiently as possible. On the other hand, a control of the buffer memory device by a control device of the edge server or an operating system of the edge server would be associated with a higher energy consumption since a control device of the edge server is not limited to the tasks of writing the camera image data and reading the camera image data to or from the data memory. Therefore, the control device of the edge server cannot be optimized exclusively for the writing and reading of data, but must so-to-say be overdimensioned with respect to these tasks to also be able to perform this specific task as a generally adapted control device. However, such an overdimensioning leads to a less efficient and therefore more energy-intensive implementation.

In general, by providing a separate buffer memory device in the data transmission path, the receiving and storing of the camera image data may therefore take place in a specialized manner, whereby, as explained, the energy requirement for this task may be reduced and a reliable receiving of the camera image data in real time may be simultaneously achieved.

In some embodiments, the control device may be connected to the data memory via a PCI Express. This may in particular also enable a fast data communication between the control device and the data memory.

In some embodiments, a write access for writing the camera image data to the data memory of the buffer memory device may be prioritized over a readout of the camera image data from the data memory of the buffer memory device for transmitting the camera image data to the edge server.

In such embodiments, it may thus be achieved that any camera image data transmitted by the motion picture camera are always written to the data memory of the buffer memory device at a higher priority to avoid any loss of camera image data, whereas a readout of camera image data from the data memory is deferred in comparison thereto. Due to the configuration of the buffer memory device with a non-volatile memory, a readout of the camera image data from the data memory is generally possible over longer time periods so that only the writing of the camera image data to the data memory, but not the readout of the camera image data from the data memory has to take place in real time. This aspect may be taken into account by the aforementioned prioritization in corresponding embodiments. In some embodiments, the camera image data may be encrypted by the buffer memory device.

For example, the above-mentioned control device of the buffer memory device may be configured to encrypt the camera image data. Alternatively or additionally, however, it may, for example, also be provided that an encryption at the data memory takes place, for which purpose an ASIC chip or an FPGA may, for example, be arranged in the region of the input/output of the data memory. In both cases, the received camera image data may in particular be encrypted before the actual writing to the data memory, wherein, in the course of a readout and/or before a transmission of the camera image data, it may, however, in particular also be provided to decrypt the camera image data again so that the camera image data may be transmitted unencrypted to the edge server. However, the camera image data stored in the data memory of the buffer memory device may be encrypted and may thus be protected against unauthorized access so that the camera image data cannot be easily read out in the event of a possible theft of the data memory either.

In some embodiments, the completeness of the transmission of the camera image data to the buffer memory device and/or to the edge server may be checked. This may in particular take place by a cyclic redundancy check and/or a Hamming code. Alternatively or additionally, in some embodiments, it may be provided that data packets of the camera image data that have not been transmitted to the buffer memory device and/or the edge server (or that have not been received at the buffer memory device and/or the edge server) are transmitted again.

In this regard, with such procedures, it may be ensured that, in actual fact, all the camera image data are ultimately transmitted to the edge server by checking the transmission of the camera image data again. For example, the motion picture camera may have a buffer memory so that camera image data already transmitted from the motion picture camera to the buffer memory device may possibly also be requested again to be able to request a subsequent transmission of a data packet that may possibly not have been received.

In some embodiments, the camera image data may be transmitted to the edge server via two parallel data paths.

For example, this may take place via a common buffer memory device comprising two data memories or via two separate buffer memory devices. A buffer memory device comprising two data memories may, for example, have a single control device, for example a smart network interface card, that is configured to write received camera image data to the two data memories. In particular, due to the provision of such parallel data paths, a redundancy in the data transmission may be achieved or a mirror memory may be provided to be able to ensure that all the camera image data may actually be received, stored and ultimately transmitted to the edge server. This may thus represent an additional safety measure to avoid any loss of data.

In some embodiments, the camera image data may be transmitted from the buffer memory device to the edge server, wherein the camera image data may, however, be processed, in particular reduced and/or compressed, in a buffer memory device. The processed camera image data may further be transmitted to an output device, in particular a monitor.

In particular, in such embodiments, the buffer memory device may thus be configured to reduce and/or compress the received camera image data in order to then transmit the camera image data processed in this way to an output device such as a monitor. This may, for example, make it possible to be able to observe the generated image data at a monitor in real time during a recording, wherein the corresponding data transmission to the monitor is, however, only possible due to the reduction in the amounts of data to be transmitted to the monitor. This task, which must be performed in real time, may thus also be performed by the buffer memory device, and in particular its control device, without the camera image data first having to be transmitted to the edge server.

In particular, it may further be provided that the camera image data processed by the buffer memory device are not transmitted to the edge server, but that the edge server only receives the unprocessed and complete camera image data. Alternatively, it is, however, also possible to transmit the camera image data processed by the buffer memory device to the edge server as well, in particular with a time delay or overlapping with the unprocessed camera image data actually to be transmitted.

In some embodiments, the camera image data may be pre-processed and/or post-processed, in particular at the edge server, wherein in particular a color correction, a correction of the pixels and/or a color processing may be performed.

In particular, such a processing of the camera image data may represent an additional task of the edge server, for which computing capacity is required, to the mere receiving and storing of the camera image data. For example, the execution of such processes may therefore possibly have the result that the capacity for receiving camera image data in real time at high data rates at the edge server may not be made available permanently. As explained, however, this problem may be countered by providing the buffer memory device in the data transmission path.

In principle, it may furthermore also be provided that the buffer memory device, in particular a smart network interface card of the buffer memory device, is configured to pre-process and/or post-process the camera image data. However, the processing performed at the buffer memory device may be comparatively simple processes in order not to impair the real-time capability of the buffer memory device with respect to the receiving and writing of the camera image data.

The camera image data may be transmitted from the edge server to a cloud-based data memory device in some embodiments, wherein the camera image data may in particular be post-processed at the cloud-based data memory device.

Consequently, the edge server may so-to-say represent a connection point for the motion picture camera in order to ultimately transmit the generated camera image data via the edge server to a cloud-based data memory device or server architecture and to be able to use the storage and computing capacity provided there to store and/or process the camera image data. This transmission to the cloud-based data memory device may, for example, also take place during or after a recording by the motion picture camera since the edge server is relieved of the task of receiving the camera image data in real time due to the arrangement of the buffer memory device.

In some embodiments, the camera image data of at least two motion picture cameras may be simultaneously transmitted to the edge server, wherein the camera image data of the at least two motion picture cameras may be transmitted to the same buffer memory device, and wherein the buffer memory device may have a respective data memory for writing in the camera image data of a respective motion picture camera. Alternatively thereto, each of the motion picture cameras may be connected to a respective associated buffer memory device and the camera image data of a respective motion picture camera may be written to the data memory of the associated buffer memory device.

In this regard, for recordings during which at least two motion picture cameras are simultaneously used, it may be provided that at least one respective data memory is available for each of the motion picture cameras to be able to write the camera image data of the different motion picture cameras separately from one another to respective data memories in real time. This may take place via a common buffer memory device that may in particular have a control device to be able to distribute the camera image data that are simultaneously received from the two motion picture cameras to the associated data memories. However, provision may generally also be made to provide a separate buffer memory device for each of the motion picture cameras in order, as a result, to be able to ensure a proper separation of the respective camera image data.

In the case of motion picture recordings with two motion picture cameras, it may therefore in particular be provided that the camera image data generated by a respective motion picture camera are written to a respective associated data memory of a buffer memory device and are then transmitted from the respective data memory to the edge server.

In some embodiments, the motion picture camera may be configured by the edge server on a connection to the edge server. In particular, the motion picture camera may for this purpose be set to a configuration previously stored at the edge server.

For example, the motion picture camera and the edge server may first negotiate a configuration and/or a recording mode of the motion picture camera on a connection of the motion picture camera to the edge server, wherein the edge server may, for example, when the motion picture camera is connected for the first time, transmit a default configuration stored on the edge server for a respective device type of the motion picture camera to the motion picture camera. However, if the motion picture camera was already connected to the edge server beforehand, the edge server may, for example, transmit a last saved configuration of the motion picture camera to the motion picture camera, wherein the motion picture camera, in particular a control device of the motion picture camera, may be configured to set the motion picture camera to the received configuration.

To be able to carry out such a configuration of the motion picture camera, it may, for example, be provided that the motion picture camera transmits camera image data with corresponding metadata for a first recorded image to the edge server, wherein, from this, the edge server may infer a current configuration of the motion picture camera and/or a device type of the motion picture camera. The edge server may then, for example, retrieve a default configuration stored for the device type or a configuration last saved for the motion picture camera in order to transmit the configuration to the motion picture camera. As an alternative to such a negotiation of the recording mode, it may further be provided that the motion picture camera directly transmits configuration data to the edge server on a connection to the edge server, whereupon the edge server may save these configuration data and/or may send adapted configuration data back to the motion picture camera.

The configuration of the motion picture camera may, for example, comprise the image format, a recording frequency and/or an image resolution so that the motion picture camera may immediately start a recording with the desired settings after receiving the configuration. The transmission of the provided configuration to the motion picture camera may generally take place via the same data path as the transmission of the camera image data to the edge server, wherein the buffer memory device, in particular a control device of the buffer memory device, may, however, be configured to transmit data received from the edge server directly to the motion picture camera while bypassing the data memory.

Furthermore, a current configuration of the camera may be saved in a write-in mode at the edge server. This may, for example, make it possible to save default configurations for previously unknown device types or a desired configuration at the edge server so that this configuration may immediately be transmitted on a subsequent connection of the motion picture camera to the edge server and the motion picture camera may be configured. This may also, for example, take place via the same data path via which the camera image data are also transmitted, but possibly omitting the data memory.

Alternatively, such a transmission of the current configuration to the edge server and/or the transmission of the configuration from the edge server to the motion picture camera may, however, also take via a data connection existing directly between the motion picture camera and the edge server (bypassing the buffer memory device) since only small amounts of data need to be transmitted in this respect.

The invention further relates to a data processing device for processing camera image data that are generated during a motion picture recording by a motion picture camera and that represent a recorded scene. The data processing device comprises an edge server that is configured to receive the camera image data and to forward the received camera image data to systems arranged downstream, and a buffer memory device comprising a non-volatile data memory. The buffer memory device has a data connection to the edge server and an interface for establishing a camera data connection with the motion picture camera and is configured to write camera image data that are transmitted to the interface to the data memory and to transmit camera image data that are written to the data memory to the edge server.

As already explained above in connection with the method for recording camera image data, such an arrangement of a buffer memory device in a data transmission path from the motion picture camera to the edge server may make it possible to receive camera image data at high data rates in real time and to reliably transmit said camera image data to the edge server by first storing the camera image data in the data memory of the buffer memory device. As explained, the buffer memory device in particular enables a temporal decoupling between the generation of the camera image data by the motion picture camera and the actual transmission to the edge server so that a system with a real-time capability with respect to the storing of the camera image data may be provided by the buffer memory device, whereas the edge server does not have to provide such a real-time capacity.

In the data processing device, one or more of the features already explained above in connection with the method or one or more of the steps explained in connection with the method may be implemented. Similarly, one or more of the features explained below in connection with the data processing device or one or more of the control steps explained below may also be implemented in the method described above.

Furthermore, the data memory device may also, in principle, be configured to receive data—at the interface—via a data connection from a device generating the data, to write said data to the data memory and to transmit data written to the data memory to the edge server via a further data connection.

As already explained, such a device generating the data may be in particular be formed by a sensor or may comprise a sensor that converts physical data into digital data. An image sensor, a LIDAR sensor, a magnetic resonance imaging sensor, a computed tomography sensor and/or an X-ray flat panel sensor (flat panel detector) may in particular be considered. Furthermore, a device generating the data may, for example, comprise AI that generates data to be stored that may be received at the interface of the buffer memory device and that may be written to the data memory of the buffer memory device.

In some embodiments, the buffer memory device may have a control device, wherein the control device may comprise a smart network interface card, an FPGA (Field Programmable Gate Array) and/or an ASIC (Application-Specific Integrated Circuit).

As already explained, this control device may in particular be an autonomous control device that may work completely independently of a control device or a server operating system of the edge server. The control device may therefore in particular be adapted to and/or optimized for receiving and writing the camera image data in real time at the required data rates.

In some embodiments, the control device may be connected to the data memory via a PCI Express (Peripheral Component Interconnect Express). The required fast writing in of the camera image data may hereby be implemented at high data rates.

In some embodiments, the control device may be configured to write camera image data to the data memory at a data rate of at least 10 Gbit per second, at least 25 Gbit per second or at least 80 Gbit per second.

In some embodiments, the control device may further be configured to prioritize the writing of the camera image data to the data memory over a readout of the camera image data from the data memory. As already explained, the main function of the buffer memory device of reliably writing in the received camera image data may hereby be prioritized and ensured.

In some embodiments, the data memory of the buffer memory device may provide a storage capacity of at least 1 TB (terabyte), at least 5 TB (terabytes), at least 10 TB (terabytes), at least 20 TB (terabytes), at least 50 TB (terabytes) or at least 100 TB (terabytes).

In some embodiments, the interface may be configured to receive the camera image data from the motion picture camera via an Ethernet connection and/or via a WLAN/WiFi connection. Alternatively or additionally, the buffer memory device may be connected to the edge server via a PCI Express (Peripheral Component

Interconnect Express). In this regard, the interface may in particular enable a flexible transmission of the camera image data from the motion picture camera (or of other data of a device generating the data), whereas the connection between the buffer memory device and the edge server via a PCI Express may enable a fast and simple data transmission from the buffer memory device to the edge server.

In some embodiments, the data memory of the buffer memory device may be replaceable.

In such embodiments, different data memories may therefore, for example, be used in the buffer memory device as required in order, for instance, be able to provide respective required storage capacities and/or also to be able to retrofit the buffer memory device, if necessary. Furthermore, for example in situations in which a recording of a subsequent scene has to be started very quickly, the transmission of camera image data to the edge server may be postponed and a possibly already completely written data memory may be replaced to be able to immediately start a recording of a subsequent scene.

In some embodiments, the buffer memory device, in particular its control device, may be configured to delete data stored in the data memory before a replacement of the data memory. This may in particular be a safety measure against a theft of the data stored on the data memory in that the data stored on the data memory may be immediately deleted when the data memory is removed from the buffer memory device. As an alternative or in addition thereto, it may, for example, also be provided, as already explained above, that the buffer memory device is configured to encrypt the camera image data that are stored in the data memory and/or are to be written to the data memory so that a readout of the camera image data is not easily possible in the event of a theft of the data memory.

In some embodiments, the buffer memory device may be configured to encrypt the camera image data.

As already explained, this may in particular be implemented by a control device of the buffer memory device, but also, for example, by an additional ASIC chip arranged at an input/output of the data memory or by an FPGA arranged at the input/output of the data memory.

In some embodiments, the buffer memory device may be configured to check the completeness of the camera image data, in particular by a cyclic redundancy check and/or a Hamming code. Alternatively or additionally, in some embodiments, the buffer memory device may be configured to request a further transmission of data packets of the camera image data that have not been transmitted to (or received by) the buffer memory device and/or the edge server and, in particular, to transmit a request for the data packets to the motion picture camera via the interface.

Therefore, the motion picture camera may in particular be configured to temporarily store data packets of the camera image data so that a further request for these data packets by the buffer memory device is possible, if necessary.

In some embodiments, the buffer memory device may be configured to compress and/or reduce the camera image data and the buffer memory device may have a second interface for outputting the compressed and/or reduced camera image data to an output device, in particular a monitor. This may make it possible to observe image data recorded by the motion picture camera at the monitor directly during the recording-in compressed and/or reduced form-and to check the recording of the scene without having to transmit the complete camera image data to the output device in real time for this purpose.

It may generally be provided that the buffer memory device directly has two physical interfaces to be able to receive the camera image data, on the one hand, and to be able to output the compressed and/or reduced camera image data, on the other hand.

However, in some embodiments, only a single physical interface may also be formed at the buffer memory device, via which interface both the camera image data may be received from the camera and the compressed and/or reduced camera image data may be transmitted to the output device. In such embodiments, for this purpose, a router may, for example, be arranged between the camera and the buffer memory device to be able to distribute the camera image data coming from the camera to the buffer memory device and to be able to distribute the compressed and/or reduced camera image data to the output device. In particular, such a configuration comprising a router and a common physical interface may be provided during a transmission of the camera image data and the compressed and/or reduced camera image data via an Ethernet connection, but also, for example, during a transmission via a WLAN/WiFi connection and possibly via a PCI Express. In such embodiments, the combination of the physical interface of the buffer memory device and the respective input/output of the router may therefore be understood as the interface for receiving the camera image data and for transmitting the compressed and/or reduced camera image data.

In some embodiments, the buffer memory device may have at least a second data memory and/or at least two buffer memory devices may be connected to the edge server.

As already explained, such a second data memory—a second data memory of a buffer memory device or a further buffer memory device with its own data memory—may in particular act as a mirror memory to enable a redundant recording of camera image data and to further avoid a loss of camera image data.

Furthermore, such a second data memory may possibly make it possible to be able to receive camera image data simultaneously generated by two motion picture cameras and to be able to write said camera image data to a respective data memory in order to then transmit the camera image data to the edge server.

In principle, the second data memory may therefore be connected to the edge server so that camera image data stored in the second data memory may also be transmittable to the edge server.

In some embodiments, the edge server may be connected to a cloud-based data memory device and may be configured to transmit the camera image data to the cloud-based data memory device, in particular via an Ethernet connection and/or a WLAN/WiFi connection. Alternatively or additionally, the edge server may be connected to a local data memory device and may be configured to transmit the camera image data to the local data memory device, in particular via a PCI Express (Peripheral Component Interconnect Express) and/or a USB (Universal Serial Bus).

In some embodiments, a configuration of the motion picture camera may be stored on the edge server and the edge server may be configured, on a connection of the motion picture camera to the interface of the buffer memory device, to transmit the configuration to the motion picture camera. As already explained, the motion picture camera may hereby be directly configured via a connection to the edge server, wherein the configuration may generally be transmitted via the same data path as the camera image data (but in a different direction) or via a separate data transmission path. Furthermore, it may be provided that a control device of the buffer memory device, in particular a smart network interface card, is configured to transmit the configuration of the motion picture camera to the motion picture camera while bypassing the data memory.

The invention will be explained in the following purely by way of example with reference to embodiment examples and to the drawings.

There are shown:

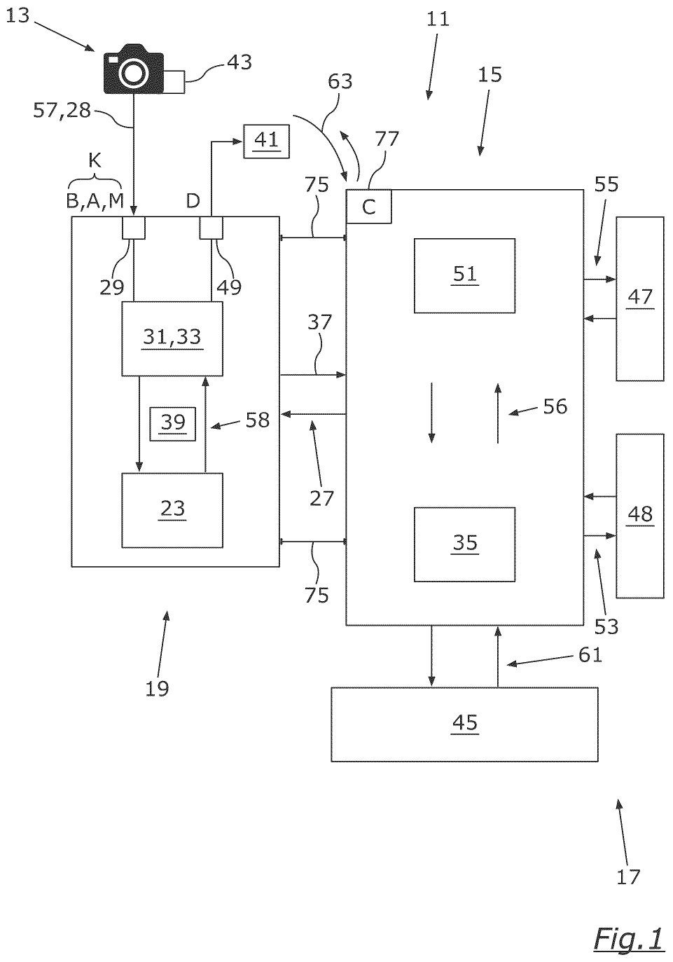

FIGS. 1 to 3 a respective schematic view of a data processing device for recording camera image data, which are generated by a motion picture camera during a recording of a scene, at an edge server, wherein a buffer memory device is arranged in a data transmission path from the motion picture camera to the edge server;

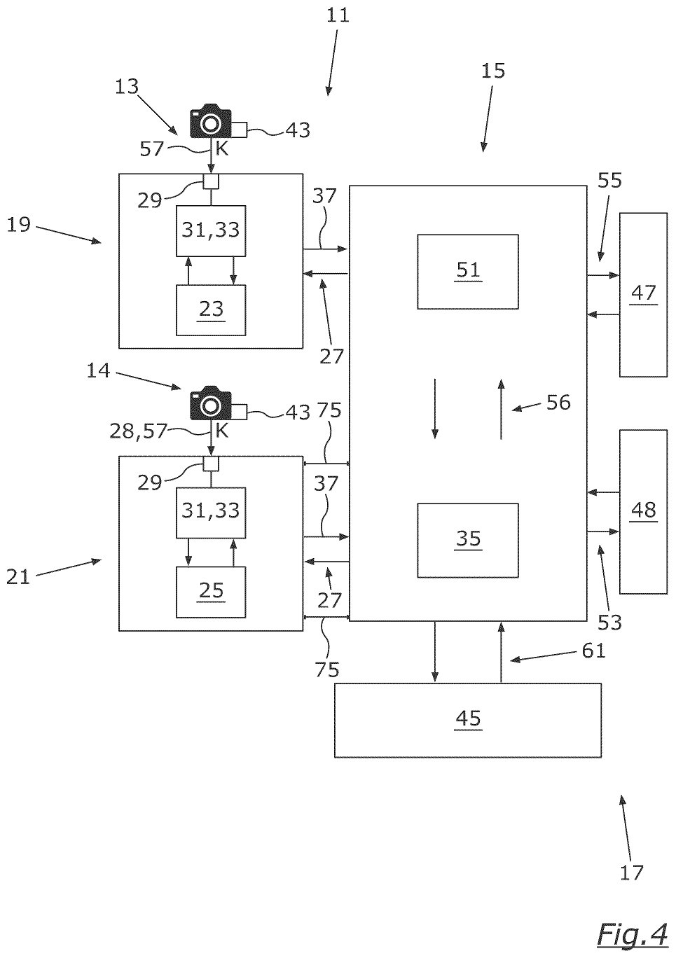

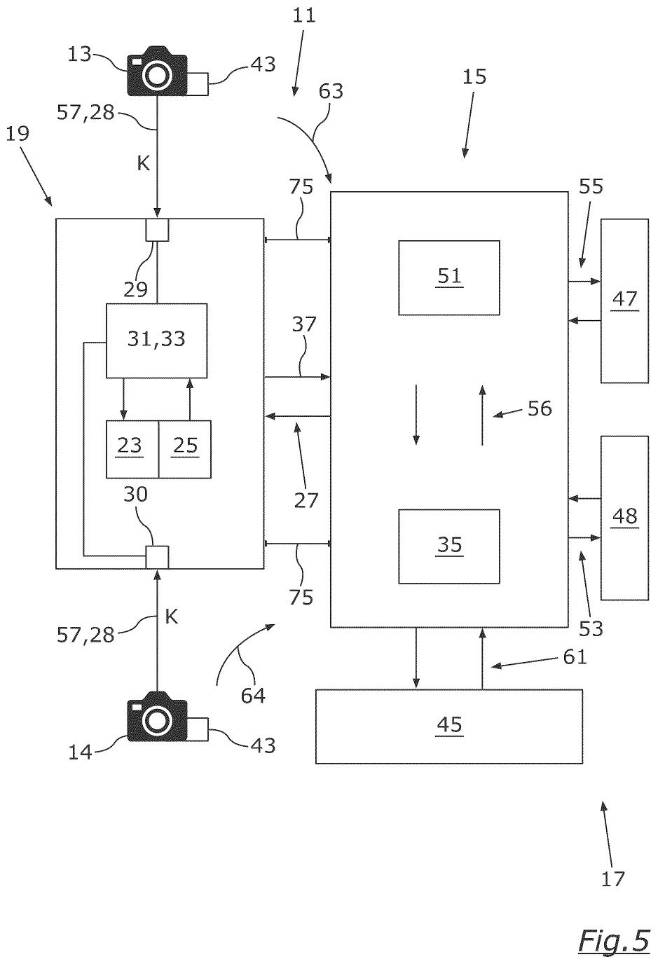

FIGS. 4 and 5 a respective schematic representation of data processing devices that enables a recording of camera image data at an edge server, wherein the camera image data are simultaneously generated by two motion picture cameras; and

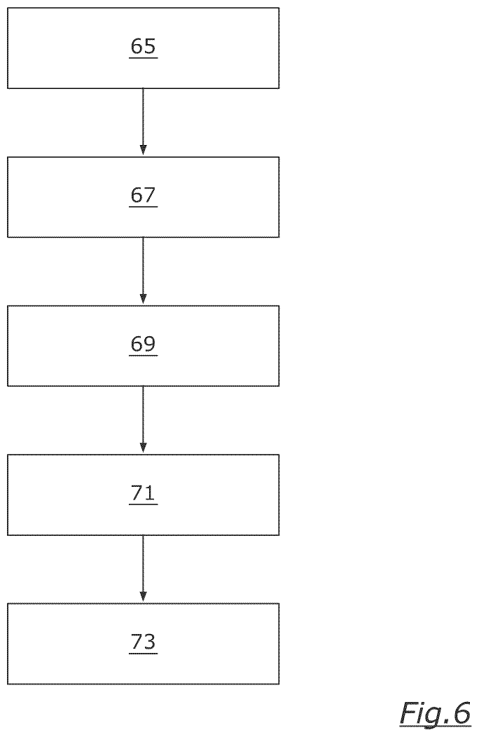

FIG. 6 a schematic representation of a method for recording camera image data that is in particular to be performed at such a data processing device.

FIG. 1 shows a data processing device 11 that is configured to record camera image data K, which are generated by a motion picture camera 13 during a recording and which represent a recorded scene, at an edge server 15. The edge server 15 is in this respect positioned close to the motion picture camera 13 and forms a connection point for the motion picture camera 13 in order to ultimately transmit the camera image data K generated by the motion picture camera 13 to systems arranged downstream 17, in particular a cloud-based data memory device 45 and/or two local data memory devices 47 and 48. In particular at the cloud-based data memory device 45, a processing of the received camera image data K may then, for example, take place, wherein the computing power available via a cloud may be used.

The motion picture camera 13 may in particular be a motion picture camera 13 adapted for professional motion picture recordings so that the camera image data K may be generated at data rates of approximately 10 Gbit per second, 25 Gbit per second, 80 Gbit per second or 100 Gbit per second. The camera image data K may in particular comprise the image data B that represent the scene recorded by the motion picture camera 13, audio data A and metadata M.

The metadata M may, for example, be a lens setting of a lens of the motion picture camera 13, an image format, a frame rate, type information about a device type of the motion picture camera 13 and/or information of a sensor of the motion picture camera 13. Furthermore, the motion picture camera 13 has a buffer memory 43 in which the camera image data K may be buffered.

To be able to reliably record the camera image data K, it is necessary to transmit all the camera image data K to the edge server 15 so that the recorded camera image data K may then be completely transmitted to the systems arranged downstream 17. However, there is generally the problem here that the data rates generated by current motion picture cameras 13, and in particular by motion picture cameras 13 to be implemented in the future, are often too high for conventional edge servers 15 to be able to ensure a recording of the camera image data K in real time. This may in particular be made more difficult in that received camera image data K at the edge server 15 may possibly also be pre-processed or post-processed by a control device 51 of the edge server 15 or its operating system so that various processes, and in particular processes in addition to the mere receiving and storing of camera image data K, may be executed at the edge server 15 and may possibly lead to dropouts or timeouts with respect to the receiving of camera image data K. However, such a dropout may, for instance, have the result that a data packet of the camera image data K cannot be received at the edge server 15 so that the camera image data K ultimately cannot be transmitted completely. At the same time, however, in view of the high data rates and large amounts of data, the motion picture camera 13 usually may not be configured with a buffer memory 43 that enables the recording of all the camera image data K generated during the recording of a scene.

To counter this problem, in the data processing device 11 illustrated by means of FIG. 1, a buffer memory device 19 is connected to the edge server 15 via a mechanical coupling 75 and, in a data transmission path 63 from the motion picture camera 13 to the edge server 15, is arranged between the motion picture camera 13 and the edge server 15. The buffer memory device 19 has a non-volatile data memory 23 that may, for example, be implemented as an HDD (Hybrid Hard Drive) memory or SSD (Solid State Drive) memory.

The arrangement of the buffer memory device 19 in the data transmission path 63 from the motion picture camera 13 to the edge server 15 makes it possible to first transmit camera image data K generated by the motion picture camera 13 to the buffer memory device 19 and to write said camera image data K to the data memory 23 in order to only then transmit the camera image data K stored in the data memory 23 to the edge server 15. A temporal decoupling between the recording of the camera image data K and the storage of the camera image data K at the edge server 15 may hereby be achieved so that the edge server 15 does not have to provide a real-time capacity with respect to the receiving of the camera image data K at the required data rates. Rather, the camera image data K may initially be stored in the data memory 23 of the buffer memory device 19 in order, for example, to be able to be transmitted to the edge server 15 only after a recording has been completed. To be able to store the required amount of camera image data K, the non-volatile data memory 23 may, for example, have a storage capacity of at least 1 TB (terabyte), at least 5 TB (terabytes), at least 10 TB (terabytes), at least 20 TB (terabytes), at least 50 TB (terabytes) or at least 100 TB (terabytes).

To enable the explained buffering of the camera image data K at the buffer memory device 19, the buffer memory device 19 has an interface 29 at which the camera image data K may be received via a camera data connection 28, in particular a local radio connection 57, for example, a WLAN/WiFi connection or an Ethernet connection. To be able to perform the writing of the received camera image data K to the data memory, the buffer memory device 19 has a control device 31 that may in particular be a smart network interface card 33. Alternatively or additionally, an implementation of the control device 31 via an FPGA and/or an ASIC may also be provided.

As can be seen from FIG. 1, the control device 31 of the buffer memory devices 19 is formed completely separately from the control device 51 of the edge server 15 and is thus configured as an autonomous control device 31. This may make it possible to adapt the control device 31 to the writing of the camera image data K to the data memory 23 of the buffer memory device 19, and thus to optimize the control device 31 for this function. The capacity for writing the camera image data K to the data memory 23 in real time may hereby be ensured, on the one hand, and, on the other hand, by specializing the control device 31 for only this function, a fulfilling of the writing of the camera image data K to the data memory 23 with the lowest possible power consumption or energy consumption may hereby be implemented.

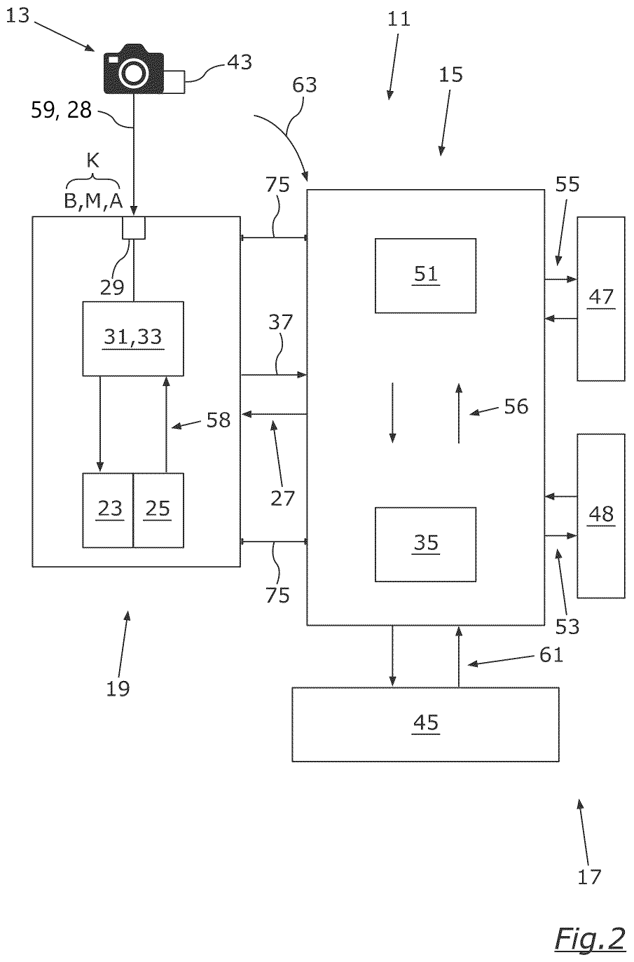

To be able to achieve a writing of the camera image data K to the data memory 23 that is as fast as possible, the control device 31 of the buffer memory device 19 is connected to the data memory 23 via a PCI Express 58. Furthermore, in the embodiment shown in FIG. 1, an ASIC chip 39 is arranged at an input/output region of the data memory 23 to encrypt the camera image data K during the writing to the data memory 23 and to decrypt said data again on a readout from the data memory 23. However, such an encryption of the camera image data K may, for example, also be implemented at the software and/or hardware side at the control device 31 so that the embodiments shown by FIGS. 2 to 5 do not have an ASIC chip in the input/output region of the data memory 23, wherein, however, an encryption of the camera image data K may nevertheless be provided. Furthermore, in some embodiments, as an alternative to the ASIC chip 39 shown in FIG. 1, an FPGA may also be arranged in the input-output region of the data memory 23 to enable an encryption of the camera image data K.

Furthermore, the buffer memory device 19 and in particular its control device 31 may also be configured to process the camera image data K and in particular to compress and/or reduce said data in order to generate processed camera image data D as a result. According to FIG. 1, the buffer memory device 19 has a second interface 49 via which the camera image data D being processed may be transmitted to an output device 41, in particular a monitor. This may make it possible to check recordings generated by the motion picture camera 13 directly at the monitor 41, even though a transmission of the complete camera image data K to the monitor 41 may not be possible due to the amount of data generated.

While the second interface 49 is provided by way of example in FIG. 1 to transmit the processed camera image data D to the output device 41, it is generally also possible that the processed camera image data D are transmitted to the output device 41 via the same physical interface 29 via which the camera image data K are also received. In such embodiments, for example, a router could for this purpose be arranged between the camera 13 and the buffer memory device 19 to be able to distribute the camera image data K coming from the camera 13 to the buffer memory device 19 and the processed camera image data D to the output device 41. Such a configuration with a router is in particular suitable for a transmission of the camera image data K and the processed camera image data D via an Ethernet connection, but may, for example, also be provided for a transmission via a WLAN/WiFi connection and possibly via a PCI Express.

To ultimately be able to transmit the camera image data K to the edge server 15, the buffer memory device 19 is connected to the edge server 15 via a data connection 27 that may in particular be implemented via a PCI Express 37. As already explained, provision may, for example, be made that the camera image data K are transmitted from the data memory 23 of the buffer memory device 19 to the edge server 15 during an interruption of a recording of the motion picture camera 13. Alternatively thereto, provision may, however, also be made that camera image data K may simultaneously be written to the data memory 23 and read from the data memory 23. However, the control device 31 of the buffer memory device 19 may be configured to prioritize the writing of camera image data K to the data memory 23 over a readout of the data memory 23 to ensure that all the camera image data K are stored in the data memory 23. Furthermore, the control device 31 may also be configured to check the completeness of the transmission of the camera image data K, for example, via a cyclic redundancy check and/or a Hamming code. The control device 31 may further be configured to request any data packets of the camera image data K that have not been transmitted to (or received at) the buffer memory device 19 and/or the edge server 15 for the motion picture camera 13 again, wherein the motion picture camera 13 may, for example, transmit the corresponding camera image data K from the buffer memory 43 to the buffer memory device 19.

To be able to transmit the received camera image data K to the systems arranged downstream 17, the control device 51 of the edge server 15 is, for example, connected via a PCI Express to an Ethernet card 35 that may then transmit the camera image data K to the cloud-based data memory device 45 via an Ethernet connection 61. A PCI Express 55 and a USB connection 53, respectively, are further provided for transmitting the camera image data K to the local data memory devices 47 and 48.

Furthermore, FIG. 1 shows that a configuration C of the motion picture camera 13 may be stored in a memory 77 of the edge server 15. The edge server 15 may be configured to transmit the configuration C to the motion picture camera 13 on a coupling of the motion picture camera 13 to the interface 29 of the buffer memory device 19 and/or on a reception of an image generated by the motion picture camera 13 or of corresponding camera image data K. For example, on a first connection of the motion picture camera 13 to the edge server 15, a default configuration C may be transmitted to the motion picture camera 13 that is associated with a device type of the motion picture camera 13. However, if the motion picture camera 13 was already previously connected to the edge server 15, a configuration C last used by the motion picture camera 13 may be transmitted to the motion picture camera 13. On a coupling with the edge server 15, the motion picture camera 13 may thereby be directly set to the required or preferred configuration C.

In this regard, the system illustrated by means of FIG. 1 comprising the motion picture camera 13 and the data processing device 11 enables a temporal decoupling between the recording of the camera image data K and the transmission of the camera image data K to the edge server 15.

In summary, the method illustrated by means of FIG. 6 may thus be performed by the data processing device 11. In a step 65, a scene may be recorded by the motion picture camera 13 and camera image data K that represent the scene may be generated by the motion picture camera 13. In a step 67, the camera image data K may then be transmitted to the buffer memory device 19 that may write the camera image data K to the data memory 23 of the buffer memory device 19 in a step 69. In particular, the camera image data K may be encrypted before or during this step 69 to be able to be stored in encrypted form in the data memory 23. If necessary, the already explained processing of the camera image data K may furthermore take place to be able to transmit processed camera image data D to the output device 41.

In a step 71, the camera image data K stored in the data memory 23 may be read from the data memory 23 and may be decrypted, if necessary. Then, the camera image data K may be transmitted to the edge server 15 in a step 73, in particular during an interruption of the recording by the motion picture camera 13.

FIGS. 2 to 5 show further embodiments of the data processing device 11 that are generally designed according to the principle explained above with reference to FIG. 1. Therefore, reference is made below primarily to the differences of the respective data processing devices 11 shown in FIGS. 2 to 5 compared to the data processing device 11 illustrated by means of FIG. 1. In this regard, one or more of the features explained above in connection with FIG. 1 may also be implemented in these further data processing devices 11.

In the data processing device 11 according to FIG. 2, provision is made that the buffer memory device 19 has an even further data memory 25 in addition to the data memory 23, wherein the camera image data K may be written to both the data memory 23 and the data memory 25. In this regard, the camera image data K may so-to-say be stored twice and the data memory 25 may act as a mirror memory for the data memory 23. This may make it possible to check and/or to further ensure the complete transmission of the camera image data K in that, even in the event of a possible disturbance of a data memory 23 or 25, the respective other data memory 25 or 23 may continue to be available and the camera image data K may be written to this data memory 25 or 23.

Furthermore, it is illustrated in FIG. 2 that the motion picture camera 13 may also be connected to the interface 29 of the buffer memory device 19 by a cable connection 59. In such a buffer memory device 19, it may further be provided that both the camera image data K from the data memory 23 and the camera image data K from the data memory 25 are transmitted to the edge server 15 via the data connections 27, wherein it is, however, also possible that the camera image data K are ultimately only simply transmitted to the edge server 15. However, on a transmission of the camera image data K from both data memories 23 and 25 to the edge server 15, the camera image data K—in view of the storage in different data memories 23 and 25—may ultimately be understood as being transmitted to the edge server via partially different data transmission paths.

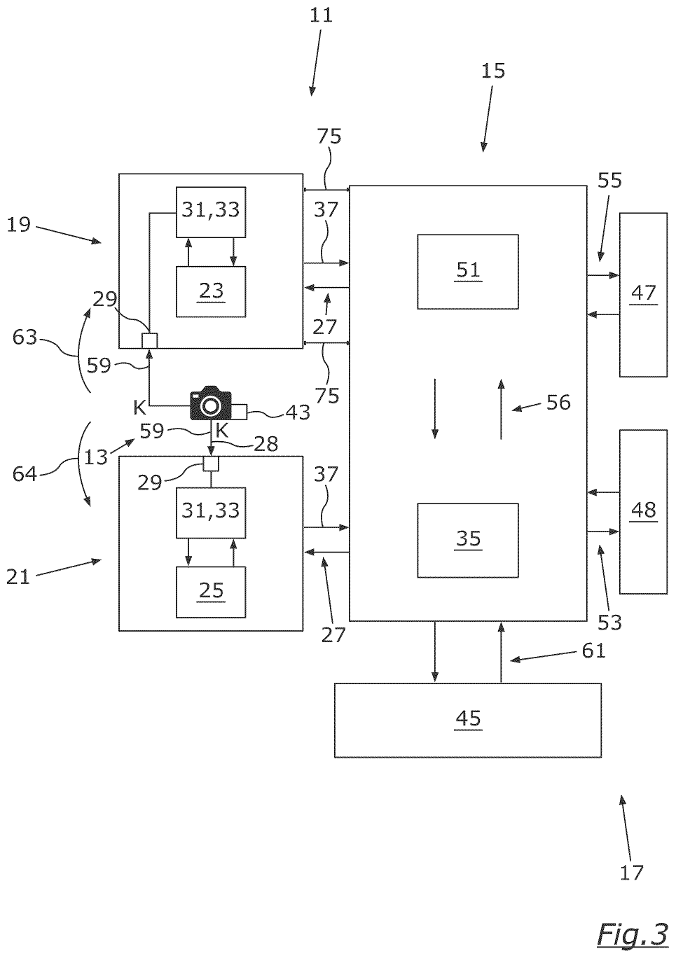

In the data processing device 11 according to FIG. 3, provision is made that camera image data K generated by the motion picture camera 13 are transmitted to the edge server 15 via two parallel data transmission paths 63 and 64, wherein a respective buffer memory device 19 or 21 is arranged between the motion picture camera 13 and the edge server 15 in each of the data transmission paths 63 and 64. In this regard, a further buffer memory device 21 comprising a control device 31, in particular a smart network interface card 33, and a data memory 25 may be provided in this embodiment and may in turn in particular function as a mirror memory for the data memory 23 and the camera image data K stored therein. Both buffer memory devices 19 and 21 may in particular be mechanically coupled to the edge server 15.

FIG. 4 illustrates an embodiment in which camera image data K must be simultaneously generated by two motion picture cameras 13 and 14 and stored. This may, for example, be provided if a scene is recorded from different angles of view. Here, too, the data processing device 11 has two buffer memory devices 19 and 21 comprising a respective data memory 23 and 25 so that the camera image data K generated by the motion picture camera 13 may be transmitted to the edge server 15 via the buffer memory device 19 and its data memory 23, whereas the camera image data K generated by the motion picture camera 14 may be transmitted to the edge server 15 via the buffer memory device 21 and its data memory 25. For both motion picture cameras 13 and 14, the camera image data K may thus first be written in real time to the respective data memory 23 or 25 of the associated buffer memory device 19 or 21 so that the edge server 15 does not have to receive any of the camera image data K of the motion picture cameras 13 or 14 in real time or have to provide a corresponding capacity for this purpose.

FIG. 5 shows a further embodiment that enables a recording of camera image data K that are generated in parallel by two motion picture cameras 13 and 14. In this embodiment, only one buffer memory device 19 is provided in a data transmission path 63 or 64 from the motion picture cameras 13 and 14 to the edge server 15. However, in addition to the interface 29 via which camera image data K may be received from the motion picture camera 13, the buffer memory device 19 has a further interface 30 to be able to receive camera image data K from the motion picture camera 14 via a local radio connection 57. The buffer memory device 19 furthermore comprises two data memories 23 and 25 so that, for instance, the camera image data K of the motion picture camera 13 may be stored in the data memory 23 and the camera image data K of the motion picture camera 14 may be stored in the data memory 25, and thus separately from one another, to be subsequently transmitted to the edge server 15. This may also enable a structured storage of the camera image data K of the two motion picture cameras 13 and 14 in real time without the corresponding capacity having to be provided by the edge server 15.

In general, it may furthermore be provided that the data memory 23 and/or 25 of at least one of the buffer memory devices 19 or 21 of the embodiments in accordance with FIGS. 1 to 5 may be replaced. In corresponding embodiments, the respective control device 31 of the buffer memory device 19 or 21 may be configured to delete any camera image data K stored in the data memory 23 or 25 before a replacement of the data memory 23 or 25 to be able to prevent a theft of the camera image data K. Furthermore, the already explained encryption of the camera image data K may also be provided in such embodiments to ensure that camera image data K stored on the data memory 23 or 25 are protected against unauthorized access.

### REFERENCE NUMERAL LIST

11 data processing device
13 motion picture camera
14 motion picture camera
15 edge server
17 systems arranged downstream
19 buffer memory device
21 buffer memory device
23 data memory
25 data memory
27 data connection
28 camera data connection
29 interface
30 interface
31 control device
33 smart network interface card
35 Ethernet card
37 PCI Express
39 ASIC chip
41 output device
43 buffer memory
45 cloud-based data memory device
47 local data memory device
48 local data memory device
49 second interface
51 control device of the server
53 USB connection
55 PCI Express
56 PCI Express
57 local radio connection
58 PCI Express
59 cable connection
61 Ethernet connection
63 data transmission path
64 data transmission path
65 step
67 step
69 step
71 step
73 step
75 mechanical coupling
77 memory
A audio data
B image data
C configuration
D processed camera image data
K camera image data
M metadata

1. A method for recording camera image data on an edge server, comprising the steps:
recording a scene by a motion picture camera and generating camera image data that represent the scene by the motion picture camera, and
transmitting the camera image data to the edge server,
wherein, in a data transmission path from the motion picture camera to the edge server, a buffer memory device comprising a non-volatile data memory is arranged between the motion picture camera and the edge server,
wherein the camera image data are first written to the data memory of the buffer memory device and the camera image data written to the data memory are then transmitted from the buffer memory device to the edge server.

2. A method according to claim 1,
wherein the camera image data comprise image data that represent respective images of the scene as well as at least one of audio data or metadata that are related to the recording.

3. A method according to claim 1,
wherein the camera image data are written to the data memory of the buffer memory device at a data rate of at least 10 Gbit per second or at least 25 Gbit per second or at least 80 Gbit per second.

4. A method according to claim 1,
wherein the data memory of the buffer memory device provides a storage capacity of at least 1 TB (terabyte).

5. A method according to claim 1,
wherein the buffer memory device is mechanically coupled to the edge server.

6. A method according to claim 1,
wherein the camera image data are transmitted at least one of:
to the buffer memory device via an Ethernet connection; or
from the buffer memory device to the edge server via a PCI Express (Peripheral Component Interconnect Express).

7. A method according to claim 1,
wherein the buffer memory device has a control device, wherein the control device comprises at least one of a smart network interface card, an FPGA (Field Programmable Gate Array) or an ASIC (Application-Specific Integrated Circuit).

8. A method according to claim 1,
wherein a write access for writing the camera image data to the data memory of the buffer memory device is prioritized over a readout of the camera image data from the data memory of the buffer memory device for transmitting the camera image data to the edge server.

9. A method according to claim 1,
wherein the camera image data are encrypted by the buffer memory device.

10. A method according to claim 1,
wherein the completeness of the transmission of the camera image data to at least one of the buffer memory device or to the edge server is checked.

11. A method according to claim 1,
wherein the camera image data are transmitted to the edge server via two parallel data transmission paths.

12. A method according to claim 1,
wherein the camera image data are transmitted from the buffer memory device to the edge server and wherein the camera image data are processed at the buffer memory device, wherein the processed camera image data are transmitted to an output device.

13. A method according to claim 1,
wherein the camera image data are transmitted from the edge server to a cloud-based data memory device.

14. A method according to claim 1,
wherein camera image data of at least two motion picture cameras are simultaneously transmitted to the edge server,
wherein the camera image data of the at least two motion picture cameras are transmitted to the same buffer memory device and wherein the buffer memory device comprises a respective data memory for writing in the camera image data of a respective motion picture camera; or
wherein each of the motion picture cameras is connected to a respective associated buffer memory device and the camera image data of a respective motion picture camera are written to the data memory of the associated buffer memory device.

15. A method according to claim 1,
wherein the motion picture camera is configured by the edge server on a connection to the edge server.

16. A data processing device for processing camera image data that are generated by a motion picture camera during a motion picture recording and that represent a recorded scene, said data processing device comprising
an edge server that is configured to receive the camera image data and to forward the received camera image data to systems arranged downstream, and
a buffer memory device comprising a non-volatile data memory,
wherein the buffer memory device has a data connection to the edge server and an interface for establishing a camera data connection with the motion picture camera, wherein the buffer memory device is configured to write camera image data that are transmitted to the interface to the data memory and to transmit camera image data that are written to the data memory to the edge server.

17. A data processing device according to claim 16,
wherein the buffer memory device has a control device, wherein the control device comprises at least one of a smart network interface card, an FPGA (Field Programmable Gate Array) or an ASIC (Application-Specific Integrated Circuit).

18. A data processing device according to claim 16,
wherein the data memory of the buffer memory device is replaceable.

19. A data processing device according to claim 16,
wherein the buffer memory device has at least a second data memory or wherein at least two buffer memory devices are connected to the edge server.

20. A data processing device according to claim 16,
wherein a configuration of the motion picture camera is stored on the edge server, wherein the edge server is configured, on a connection of the motion picture camera to the interface of the buffer memory device, to transmit the configuration to the motion picture camera.
